(19) United States
(12) Patent Application Publication
(10) Pub. No.: US 2004/0040349 A1
(43) Pub. Date: Mar. 4, 2004

(54) System, apparatus, and method for anti-theft protection of information storage media

(75) Inventors: David A. Guttadauro, Brookfield, NH (US); Keith M. Orr, Boston, MA (US); Steve C. Lepke, Wakefield, MA (US)

Correspondence Address: TESTA, HURWITZ & THIBEAULT, LLP, HIGH STREET TOWER, 125 HIGH STREET, BOSTON, MA, 02110, US

(73) Assignee: Security Source, Inc., Peabody, MA

(21) Appl. No.: 10/367,632

(22) Filed: Feb. 14, 2003

Related U.S. Application Data
(60) Provisional application No. 60/357,509, filed on Feb. 15, 2002.

(51) Int. Cl. E05B 65/00; B65D 85/57; B65D 85/575

(52) U.S. Cl. 70/57.1; 70/63; 206/1.5; 206/308.2; 206/387.11

(57) ABSTRACT

The invention provides various configurations, apparatus, methods and systems for anti-theft protection of information storage media generally comprising locking the media between opposing pieces that must be decoupled before the media may be used. In one embodiment, media packaging is equipped with a locking device. The locking device includes a head that is connected to a base by a stem. The head includes an engagement surface beneath which a locking hub mechanism is locked. The mechanism includes spring loaded locking members that are biased towards a locking hub center. The locking device is unlocked by a release device which forces the locking members away from the locking hub center, thereby disengaging the locking hub from the post.

### CROSS REFERENCE TO RELATED APPLICATIONS

This application claims priority to U.S. provisional application serial No. 60/357,509, filed Feb. 15, 2002, the entire disclosure of which is incorporated by reference herein.

### FIELD OF THE INVENTION

The invention relates, generally, to a device for use with information storage media and, more particularly, to anti-theft apparatus, methods, and systems for use with information storage media.

### BACKGROUND OF THE INVENTION

Information storage media in the form of disks (e.g., CDs, DVDs), diskettes, tapes and the like are prevalent in modern society. Generally, such media is used to store data. For example, data in the form of music, movies, documents, videos, presentations, games or the like may be stored on such media. This form of data storage is advantageous because it provides high information storage densities. Also, media stored in such a form provides greater resolution, greater accuracy, and greater reliability. Today, not only movies but video games and music can be bought or rented at commercial outlets. However, the small size, the portability, and the content of information storage media available at both rental stores and retail outlets create an increased opportunity and motivation for media theft. Currently, there are different forms of media anti-theft protection available. These forms suffer from certain drawbacks.

Often, information storage media is stored in packaging that includes one or more spindles upon which the media is set. Current anti-theft technology includes the addition of magnetic or radio-frequency detectable tags on the packaging. These tags are removed or desensitized by the store clerk at time of sale or rental. An alarm notifies store personnel when an individual attempts to leave a facility with media and the tagged packaging. Attempts can be made to apprehend the thief in response to the alarm. However, media may be removed undamaged from the packaging to defeat this approach. Once removed from its packaging, the media may be hidden by a thief and removed undetected from the store.

Retailers have also attempted to reduce the high theft rate by enclosing the media packaging within a keeper. A keeper is a larger, more durable storage case with a locking means to prevent access to the media packaging which is inserted inside the keeper. Keepers are unlocked and removed at the checkout counter when the media is rented or sold. However, keepers may also be easily defeated by a thief who employs commonly available hand tools. Further, these keepers add an independent and often bulky piece of hardware to media storage. Additionally, the space taken up by keepers reduces both the media display space and the media storage space. Thus, the amount of media that is available for sale or rental at a retail establishment is reduced. Additionally, the keeper requires increased package handling, thereby increasing the transaction time for every transaction.

Other anti-theft devices have been tried with varying success. For example, packaging locks have been used to seal the media within the package until checkout. However, since media packaging is generally manufactured from thin plastic material, these alternatives may be defeated with simple tools such as screw drivers, knives, and razorblades.

Locking devices that secure the media to the media storage case have also been employed. However, these locks are also ineffective against a thief armed with a sharp cutting tool, (e.g., a knife) because these locks generally engage the existing plastic spindle located within the case. As such, a need remains for more effective anti-theft devices for use with information storage media.

### SUMMARY OF THE INVENTION

The invention provides an anti-theft locking device, locking method, and locking system for use with information storage media. In one embodiment, the device cannot be easily defeated with commonly available concealable tools including knives and razorblades. Because the locking device cannot be easily separated from the media or media packaging, the locking device provides positive protection against the most common means of theft. Additionally, such an approach greatly reduces the theft motive because it employs a benefit denial scheme, e.g., the lock cannot be removed from the media without damaging the media and/or the contents of media. In another embodiment, the lock is removable with the use of, for example, a release device or other decoupler.

In general, the locking device is designed for integration with a variety of existing media packaging. In one embodiment, the locking device can be retrofitted into existing packaging to eliminate unwieldy and comparatively ineffective devices that are being used today. Additionally, the locking device may be employed with existing security measures such as those described above. Because the locking device may, in one embodiment, be unlocked by the release device with a minimum of movement and force, removal of the locking hub from the remainder of the packaging can be accomplished in seconds by store clerks, with minimal training.

In one aspect, the invention provides a locking device for use with an information storage media. The locking device includes a post that has a head on a first end a base on a second end and a stem located therebetween. The locking device also includes a hub that secures to the head. At least one of the hub and the head includes a locking member that operates in a radial direction to allow removable engagement of the hub and the head. In use, the stem passes through an opening located within an information storage media and the media is locked by securing the hub to the head. As a result, the media is located between the base and the head on the stem. In one embodiment, the locking member operates in a radially inward direction to lock the hub to the post. Further, in one embodiment, at least one of the head and the post includes an engagement surface. The locking member contacts the engagement surface when the hub is engaged with the post. In a further version, the hub includes at least one port into which one or more keys are inserted in order to operate the locking member. In still a further embodiment, the external surfaces of the locking device are manufactured from material that substantially resists cutting.

In a further aspect, the locking device is incorporated as part of an anti-theft system. The anti-theft system also includes a release device that has a first key and second key. In use, the first key applies a first release force in a first direction and the second key applies a second release force in a second direction. Further, the first direction and the second direction are different. The locking device is unlocked when both the first release force and second release force are applied to the locking device. In a further embodiment of the anti-theft system, the locking device is unlocked when the information storage media is either sold or rented. In a further version of this embodiment, the media is a disk (e.g., CD, DVD), and the release force is applied in a direction substantially parallel to a planar surface of the disk.

In another embodiment of the locking device, the locking device is included with information storage media packaging. The packaging includes a media storage cavity. In one version, when the locking device is in use, the head is located within the media storage cavity and the base remains external to the media storage cavity. Additionally, each of the preceding aspects and embodiments render the information storage media inoperable when the locking device is secured to the media.

In another aspect, a release device is provided for removing the locking device from the information storage media. The release device includes an operating mechanism with at least two keys. The keys engage the locking device and move in different directions to unlock the locking device. Once unlocked, the locking device may be removed from the information storage media. In one embodiment, the release device includes a lockout device that disables the release device until an authorization signal is received by the release device. In a version of this embodiment, the authorization signal is produced by a computer system when the media is either sold or rented. In a further embodiment, the release device is in electrical communication with the computer system and the computer system provides the authorization signal. In a version of this embodiment, the computer system comprises an inventory tracking program. In another version, the computer system comprises a theft detection program. In a third version, the computer system comprises a point-of-sale system.

A description of various embodiments of the invention is provided below for the purpose of illustrating the invention. The description is not intended to, and should not be seen as, limiting the invention to one or more of the embodiments or the detailed descriptions that are provided.

### BRIEF DESCRIPTION OF THE DRAWINGS

FIG. 1 is an exploded view of an embodiment of locking device in accordance with the invention.

FIG. 2 is an exploded view of an embodiment of locking hub in accordance with the invention.

FIGS. 3A-3C are plan and elevation views of an embodiment of post in accordance with the invention.

FIGS. 4A-4C are plan, elevation and perspective views of another embodiment of a post in accordance with the invention.

FIG. 5 is a perspective view of a post included with product packaging in accordance with the invention.

FIG. 6 is a perspective view of release device with the cover removed in accordance with the invention.

FIGS. 7A-7D are plan, elevation, and sectional views of a release device in accordance with the invention.

FIG. 8 is a front sectional view of a release device in accordance with the invention.

FIGS. 9A and 9B are right side sectional views of the release device of FIG. 7B.

FIG. 10 is a right side sectional view of the release device of FIG. 7B with the locking device unlocked and the hub removed from the post.

FIGS. 11A and 11B are further right side sectional views of the release device of FIG. 7B that show a lockout device in accordance with the invention.

FIGS. 12A and 12B are still further right side sectional views of the release device of FIG. 7B.

FIGS. 13A-13D are plan and sectional views of another embodiment of a locking device in accordance with the invention.

FIGS. 14A and 14B are plan and sectional views of yet another embodiment of a locking device in accordance with the invention.

FIGS. 15A and 15B are plan and perspective views of an embodiment of locking device and a locking member in accordance with the invention.

FIGS. 16A-16D are plan and sectional views of another alternative embodiment of a locking device in accordance with the invention.

FIGS. 17A-17D are plan and sectional views of a further embodiment of the locking device in accordance with the invention.

FIGS. 18A-18F are various embodiments of keys in accordance with the invention.

### DETAILED DESCRIPTION

Information may be stored using media such as disks (e.g., CDs, DVDs, laser disks), diskettes, tapes, and the like. Depending on the media, the information may be retrieved from a tape drive, a magnetic drive, or an optical drive. The media is, generally, small, compact, and has a large storage capacity. When not in use, the media is stored within packaging such as a plastic storage case. The packaging is, generally, thin and provides little or no anti-theft protection. Additionally, the packaging is used to advertise the content of the media, and to prevent the media stored inside from being damaged when not in use. Such packaging is common in both media rental outlets and media sales outlets.

Generally, the media includes an opening, often centrally located (e.g., the hole in the center of a CD or DVD that allows the media to be placed on a spindle and spun during playback). In storage, the media is pressed, via the opening, onto a spindle located within the packaging, e.g. a storage case. The media is removed from the packaging prior to use. In use, the media is placed in a reading device or drive that retrieves the stored information from the media and provides it to one or more users in one or more formats such as audio format, visual format, audio/visual format, and the like.

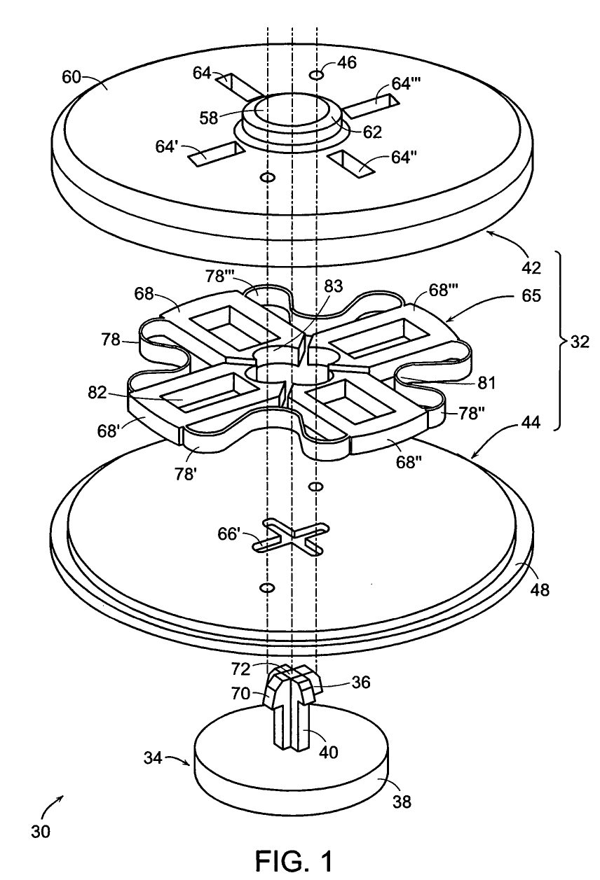

In FIG. 1, one embodiment of a locking device 30 is shown. In this embodiment, locking device 30 includes a hub 32 and a post 34. The post 34 includes a head 36 and a base 38 connected by a stem 40. The hub 32 has a housing comprising a top plate 42 and a bottom plate 44 that are secured together. A cavity is formed between top plate 42 and bottom plate 44 when they are joined together. Top plate 42 and bottom plate 44 can be secured to one another by any number of means including fasteners such as, for example, screws, or bolts which may be inserted within fastener openings 46 that are located in top plate 42 and bottom plate 44. In one embodiment, one or more of these fastener openings 46 are threaded. In another embodiment, the top and bottom plates 42, 44 are fastened together via welding around all or a portion of rim 48, where top and bottom plates 42, 44 meet. In still a further embodiment, the plates are glued together. In still another embodiment, the plates are molded or fused together. In still a further embodiment, a compression fit secures top plate 42 to bottom plate 44. In the embodiment shown in FIG. 1, hub 32 is circular in shape. However, the hub 32 shape can vary so long as hub 32 secures the media to post 34.

In the embodiment shown, the top plate 42 is multi-tiered and includes an upper tier 58, and a lower tier 60. A sloped edge 62 tapers away from upper tier 58. The top plate 42 includes at least one port 64 that allows access to lock mechanism 65. Bottom plate 44 also includes a central opening 66 and a rim 48. The rim 48 defines the outside diameter of the hub 32. The size and shape of central opening 66 allow all or a portion of head 36 and stem 40 to pass through it when hub 32 is engaged with post 34.

According to the embodiment shown in FIG. 1, locking device 30 comprises a lock mechanism 65 that is located in the cavity within hub 32. As shown in FIG. 1, the lock mechanism 65 includes one or more locking members 68, 68′, 68″ 68″′ and one or more lock springs 78, 78′, 78″, 78″′. In one embodiment, locking member 68 is a slide. In the embodiment shown in FIG. 1, lock springs 78 apply a radially inward directed locking force to the locking members 68. However, the locking force may be applied in other directions such as radially outward, axial, and the like provided that the locking force locks hub 32 and post 34 together when they are engaged. Many types of lock springs 78 may be used such as a single spring, multiple springs, multiple independent springs, and the like provided that each of the locking members 68 has a locking force applied to it. Additionally, the lock spring 78 shape may vary and can include one or more spring lobes 81, helical springs, leaf springs and the like. Further, lock spring 78 may directly apply a locking force to either a single locking member 68 or multiple locking members 68. For example, as shown in FIG. 1, each spring 74 is connected to two locking members 68.

In one embodiment, each locking member 68 includes an engagement opening 82. In the fully assembled hub 32, engagement openings 82 are aligned with ports 64, 64′, 64″, 64″′ to allow for engagement of a release device with lock mechanism 65 when the locking device 30 is unlocked. In the embodiment of FIG. 1, the engagement openings 82 are rectangular in shape and substantially centrally located in the locking member 68. However, the engagement openings 82 may be located anywhere in lock mechanism 65 provided that they allow locking device 30 to be unlocked by a release device. Further, the engagement openings 82 may be any shape such that a release device is able to engage the lock mechanism 65 to unlock locking device 30. The locking member 68 also includes an inner face 83. Inner face 83 may also comprise a tapered face with a curved surface that points toward the center of the hub 32 when the hub 32 is assembled. The tapered face enhances lock mechanism 65 to head 36 engagement when the hub 32 is pressed onto the post 34.

In FIG. 1, four ports 64 are located symmetrically around the circumference of top plate 42. However, any quantity of locking members 68 may be used and they need not be placed in a symmetrical configuration. Additionally, locking members 68 may be gang operated such that a release device directly engages fewer than all locking members 68. In this embodiment, an engagement opening 82 is not required in each locking member 68. In a further embodiment, locking member 68 may be operated without direct contact with a release device. For example, a magnetic release may serve to move one or more of locking members 68. In this embodiment, engagement openings 82 are not required.

In one embodiment, the lock mechanism 65 formed by the locking members 68 and the springs 78 is a single piece. The lock mechanism 65 may be manufactured from metal, plastic, or other materials provided that the material can provide suitable spring pressure on the locking members 68. In one embodiment, the lock mechanism comprises a spring that can be subjected to repeated compression. In another embodiment, the spring is made of stainless steel that is heat treated to bring it up to spring temper. In another embodiment, the stainless steel is 17-7 stainless steel. The top and bottom plates 44, may also be manufactured from a variety of materials. In one embodiment, each of the top and bottom plate 44 are manufactured from stainless steel. In another embodiment, the stainless steel is 304. In yet another embodiment, the underside of bottom plate 44 is covered with a cushion to reduce any risk of damage to the media. In a further embodiment, the cushion is made of rubber. However, it will be recognized by those of ordinary skill in the art, that the cushion can be made from a wide variety of materials such as plastic, fabric, synthetic materials and the like.

In each of the preceding embodiments the hub 32 can be encapsulated with a powder coating or epoxy to provide a more cosmetic finish. In one version of this embodiment, top plate 42 of hub 32 is epoxy coated.

Post 34 may also have a ledge 70 and an engagement surface 71. In one embodiment, the engagement surface 71 is located on the underside of the head 36, and ledge 70 is located between a top surface 72 of head 36 and engagement surface 71. In a further embodiment, the ledge 70 is sloped such that the head 36 diameter is greatest nearer the base 38 and gradually decreases in diameter as the head 36 extends away from the base 38. Top surface 72 may comprise any shape provided that it allows for engagement between post 34 and hub 32. In one embodiment, top surface 72 has a shape that is selected from the group consisting of circular, triangular, parallelogrammatic, polygonal, and cross-shaped.

The post 34 can be manufactured from a variety of other materials such as, for example, metal, metal alloy, ABS, polycarbonate, or high carbon plastic material. In one embodiment, the material substantially resists cutting by knives, razors, or other means, particularly, commonly available concealable means. The post 34 may be one integral piece or may comprise one or more independent pieces connected together by various means, for example, welding. In one embodiment, the post 34 is manufactured from zinc using a die-cast process.

In general, locking members 68 having a tapered inner face 83 may be used with heads 36 that are not equipped with a sloped ledge 70. Conversely, locking members 68 lacking a tapered inner face 83 can be used with heads 36 equipped with a ledge 70 that is sloped. The slope 70 should be gradual enough to allow the locking members 68 to be pushed away from the hub 32 center when hub 32 is pressed onto post 34. Some embodiments that have tapering on both locking member 68 and head 36 may also be suitable.

Various manufacturing methods may be employed to manufacture the entire hub 32 and post 34 or components thereof. These methods include machining, stamping, molding and the like. In a one embodiment, hub 32 is manufactured from materials such that hub 32 withstands a minimum of 1000 operations. In another embodiment, hub 32 will withstand a minimum of 10,000 operations. However, in an alternate embodiment, hub 32 and post 34 are employed in a low duty cycle version designed to withstand many fewer operations. In a version of this embodiment, locking device 30 is disposable.

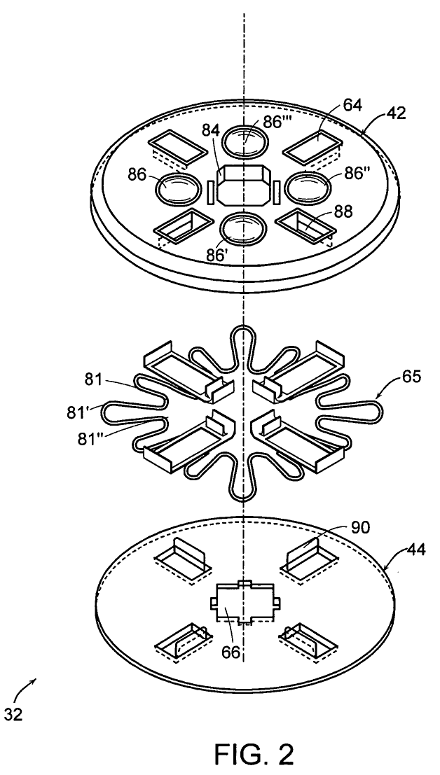

Referring to FIG. 2, another embodiment of hub 32 is shown. The hub 32 includes top plate 42, bottom plate 44, and lock mechanism 65, a top plate central opening 84 and dimples 86, 86′, 86″, 86″′. The top plate central opening 84 allows top surface 72 of post 34 to extend through top plate 42. Dimples 86 provide locations for a welded connection between top plate 42 and bottom plate 44. From the underside of the top plate 42, a top plate extension 88 extends perpendicularly downward along an edge of port 64.

In the embodiment shown in FIG. 2, the bottom plate 44 also includes a purality of ports 64 and a central opening 66. A bottom plate extension 90 extends perpendicularly upward from bottom plate 44 and a top plate extension 88, extends perpendicularly downward from the edge of each port 64. Each locking member 68 includes a rectangular opening that is substantially centrally located in the locking member 68. An engagement face is located at the radially inward end of locking member 68. The port 64 may have a shape that is substantially the same as the engagement opening 82 in the corresponding locking member 68. Each locking member 68 is attached to a lock spring 78 on either side of the radially outward end of the locking member 68, and each lock spring 78 is attached between two locking member 68. The lock spring 78 can include a single spring lobe 81 as shown in FIG. 1 or multiple spring lobes 81, 81′, 81″ as show in FIG. 2.

In a fully assembled hub 32, top plate extension 88 and bottom plate extension 90 penetrate opposite sides of engagement openings 82. This configuration helps maintain a proper mechanism alignment in hub 32. Further, these extensions assist in protection the locking device 30 from tampering.

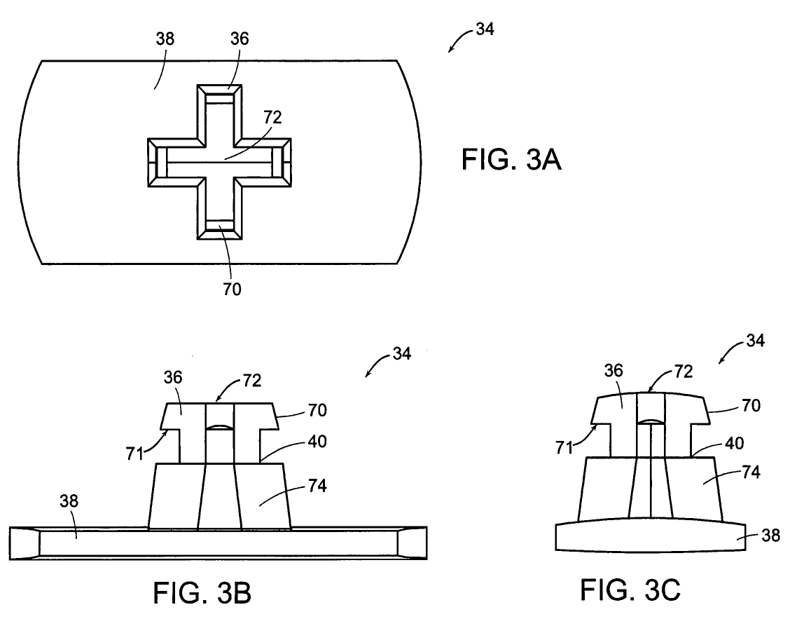

Referring to FIGS. 3A-3C, detailed views of an embodiment of post 34 are shown. The post 34 includes a base 38 and head 36 that are coinjected by stem 40. The head 36 includes ledge 70, engagement surface 71, and top surface 72. In the embodiment shown in FIGS. 3A-3C, top surface 72 is a cross-shaped surface. However, the top surface 72 may be any shape provided that the shape allows locking engagement between hub 32 and post 34. Stem 40 includes a shoulder 74 which can be used to provide a friction fit with the media that the post 34 is employed with. Thus, the diameter of shoulder 74 is approximately equal to the diameter of the opening in the media in which post 34 is employed. As shown in FIGS. 3A-3C, the shoulder 74 diameter is tapered. As viewed in FIG. 3A, the dimensions of base 38 are large enough that base 38 can not fit through the opening in the media in which the post 34 is employed. Top plate extension 88 and bottom plate extension 90 are located on opposite sides of port 64. The extensions 88, 90 are located within engagement openings 82 when hub 32 is fully assembled, and act to maintain lock mechanism 65 in proper alignment within hub 32

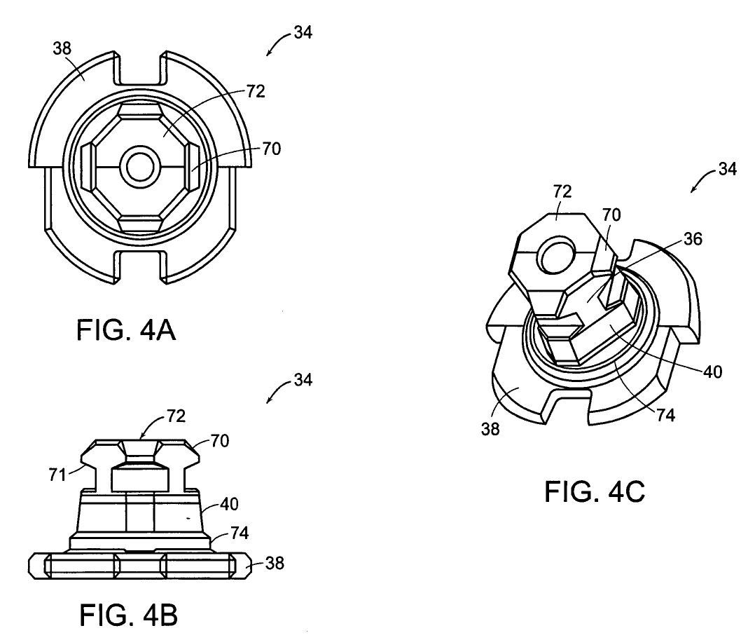

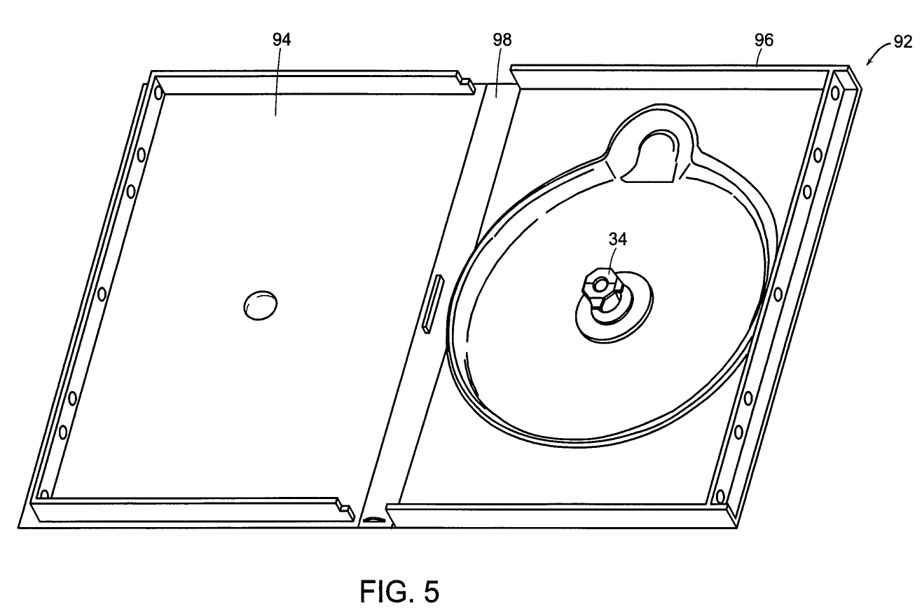

Referring to FIG. 4, a further embodiment of a post 34 is shown. The post 34 of FIGS. 4A-4C also includes a base 38 and a head 36 that are connected by a stem 40 that is located therebetween. Top surface 72 has a polygonal shape and multiple ledges 70 located around the edge of top surface 72. Ledge 70 includes a slope that gradually increases the diameter of the head 36 from top surface 72 to engagement surface 71. Additionally, the engagement surface 71 is sloped such that the diameter of the head 36 gradually decreases from the end of the engagement surface 71 that is nearest the stem 40. The diameter of stem 40 varies. The end of stem 40 adjacent to base 38 includes a shoulder 74 that provides the largest diameter of stem 40. Base 38 comprises four flanges. In one embodiment, the flanges shown in FIGS. 4A-4C are configured such that the post 34 is integrated in media package 92 that is formed by manufactured via injection molding, in such a fashion that the post 34 may be forcibly removed from packaging with a force that is less than the force required to break the locking device 30 open. One advantage to this configuration is that it supports a benefit denial scheme whereby a thief cannot remove the locking device 30 from the media without damaging the media. Where the post 34 is integrated in an injection molded package the shoulder 74 may be fully encapsulated in the package along with base 38. This approach may be employed such that the opening in the media has a friction fit with the encapsulated shoulder 74 when the media is stored in the package 92 period. When this embodiment is employed, the diameter of stem 40 is slightly less then the diameter of the opening of media with which the post 34 is employed.

In use, an opening in an information storage media is aligned with the post 34 and a portion of the post 34 passes through the opening. In one embodiment, the head 36 and a portion of the stem 40 pass through the opening in the media. The bottom plate 44 opening is aligned with post 34. Hub 32 is lowered onto the head 36 and the faces of each locking member 68 engage the ledge 70. The locking force is overcome as the hub 32 is pushed downward. The locking members 68 are forced away from the hub 32 center in a linear motion. Further, when the media is a disk, the travel is parallel to the planar surface of the disk. When the hub 32 has been pushed downward far enough to eliminate contact between the tapered faces and the ledge 70, the lock springs 78 drive each locking member 68 back towards the hub 32 center. The locking member 68 inner ends are pressed beneath the engagement surface 71. The faces can contact the stem 40, however, this is not necessary provided that locking member 68 and head 36 are engaged such that they cannot be separated without employing a release device to unlock the hub 32 from the head 36. Thus, the locking device 30 is secured with the media retained about the stem 40 between the base of post 34 and the bottom plate 44 of hub 32. The diameter of the hub 32 including both the top plate 42 and the bottom plate 44 is greater than the diameter of an opening in the media through which the lock is applied when in use. Thus, attempts to remove the hub 32 from the post 34 will be ineffective unless all of the locking members 68 are retracted when the attempted removal occurs.

Various embodiments of locking device 30 may be employed with media packaging. Generally, the packaging will be made of plastic or other material that is relatively inexpensive and easy to produce in the desired configuration. However, the invention can be used with packaging manufactured from any number of materials such as alloys, metal, woods, synthetics, and the like.

The locking device 30 can be employed with the information storage media alone, or the information storage media and packaging. FIG. 4 provides an example of one embodiment in which, during package manufacture, the post 34 was integrated in a package 92 in the form of a case. The package 92 includes a first flap 94 and a second flap 96 attached to one another at a centrally located spine 98. A post 34 is configured with the second flap 96 in place of the typical storage spindle. In a version of this embodiment, base 38 is fully enclosed in the material that comprises the second spindle. Further, the material comprising the second flap 96 may extend above the base 38 along shoulder 74 located at the end of the stem 40 that is closest to base 38. This approach allows the opening in the media to contact the packaging material at the shoulder 74 in a friction fit. Thus, it prevents direct contact between the opening in the media and post 34 when the media is stored within package 92.

In one embodiment, post 34 is retrofitted to an existing case by removing the existing spindle and creating a small circular opening in the second flap 96 where the spindle was formerly located. The post 34 is then inserted into the packaging through the back of the second flap 96 such that the base 38 is retained on the back of the second flap 96 and the head 36 and stem 40 are inside the second flap 96. The insertion is possible because of the opening created when the spindle is removed. In an alternative embodiment, the base 38 of the post 34 is set inside the second flap 96. In both of the preceding embodiments, the base 38 may be bonded to flap 96 with an adhesive such as glue, or epoxy. In a further embodiment, the base 38 is secured to the flap by tape. In an alternate embodiment, the post 34 is included as an integral part of newly manufactured packaging. For example, the post 34 can be incorporated in packaging that is manufactured via injection molding. The locking device 30 can be incorporated in any of the preceding embodiments such that post 34 extends through first flap 94 when package 92 is closed. Hub 32 remains outside the closed packaging 92 and adjacent first flap 94 when it is locked to post 34 at head 36. This configuration eliminates the need to open package 92 to unlock the media. In one embodiment, locking device 30 is employed with packaging that comprises a sleeve within which the media is stored.

A media storage cavity is formed within the closed package 92, between first flap 94 and second flap 96. The information storage media or media is located within the media storage cavity.

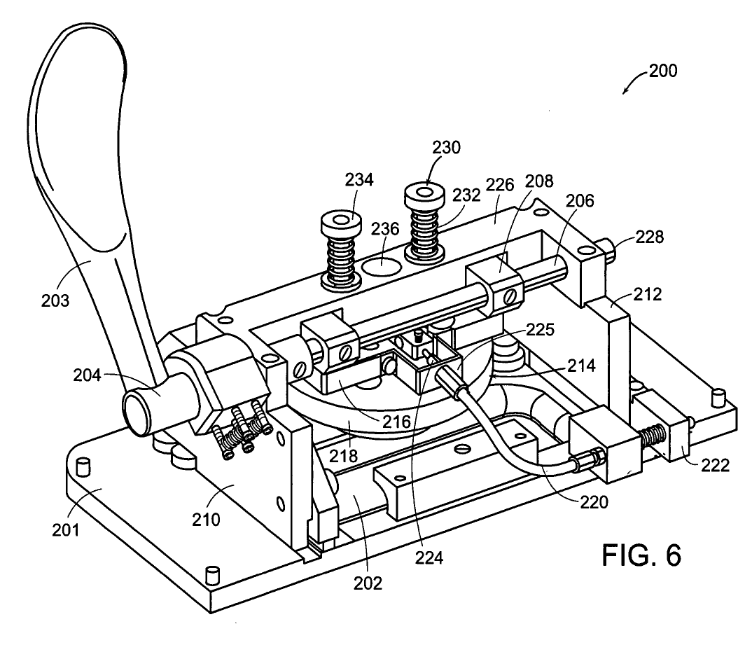

An embodiment of a release device 200 for use with locking device 30 is shown in FIG. 6. FIG. 6 shows a rear perspective view of release device 200. Release device 200 includes a base 201 that includes at least one opening 202. An operating arm 203 is connected to a first end 204 of a shaft 206. The shaft 206 includes one or more cams 208. In one version of this embodiment, a keyed shaft 206 is used. Shaft 206 is secured at the top of a first pedestal 210 and a second pedestal 212 and is oriented horizontally. The cams 208 engage an operating mechanism 214. The operating mechanism 214 comprises an upper plate 216 and a middle plate 218. A cable 220 is connected from a release lever 222 located adjacent the second pedestal 212 to a release pin 224. A mounting bracket 225 is used to attach the release pin 224 to the operating mechanism 214. A crossbar 226 extends across the release device 200 from the first pedestal 210 to the second pedestal 212. The first end 204 of shaft 206 and a second end 228 are located at opposite ends of the crossbar 226. Vertical pins 230 extend above the crossbar 226. A vertical spring 232 is located between a head 234 of the vertical pin 230 and the crossbar 226. A guide hole 236 is also located in crossbar 226. Each vertical pin 230 also extends below the crossbar 226 where they engage the operating mechanism 214.

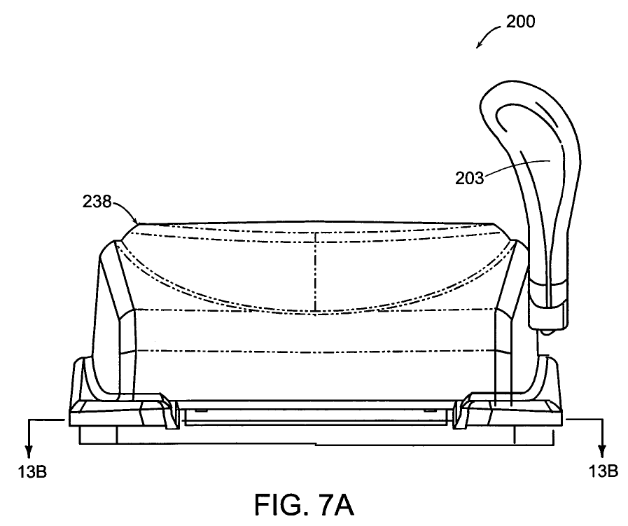

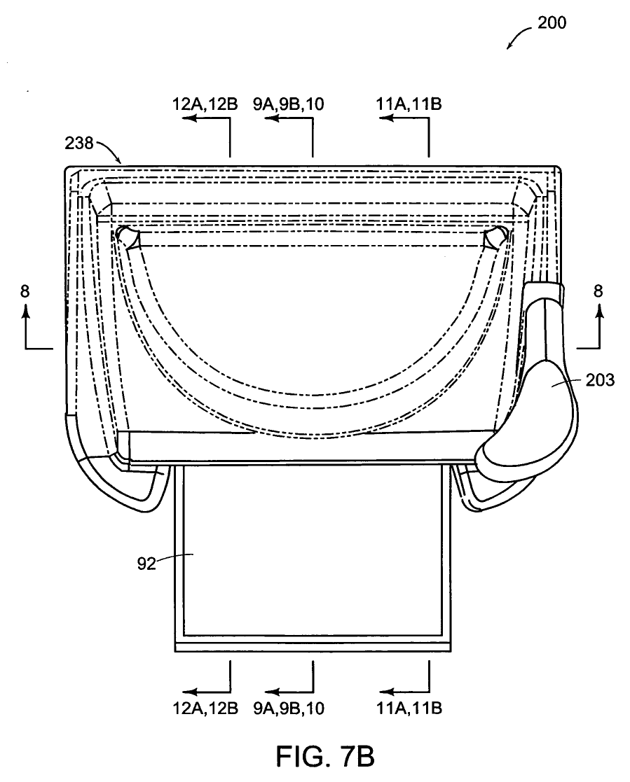

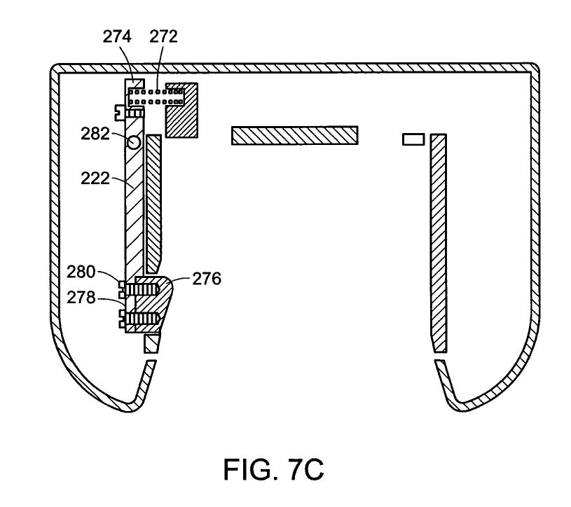

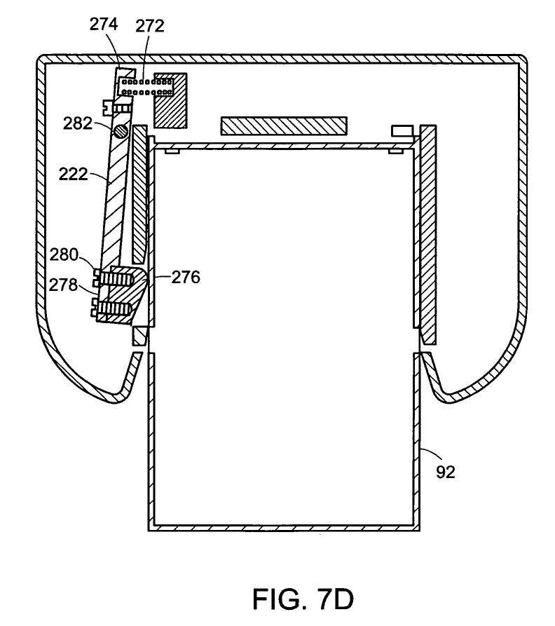

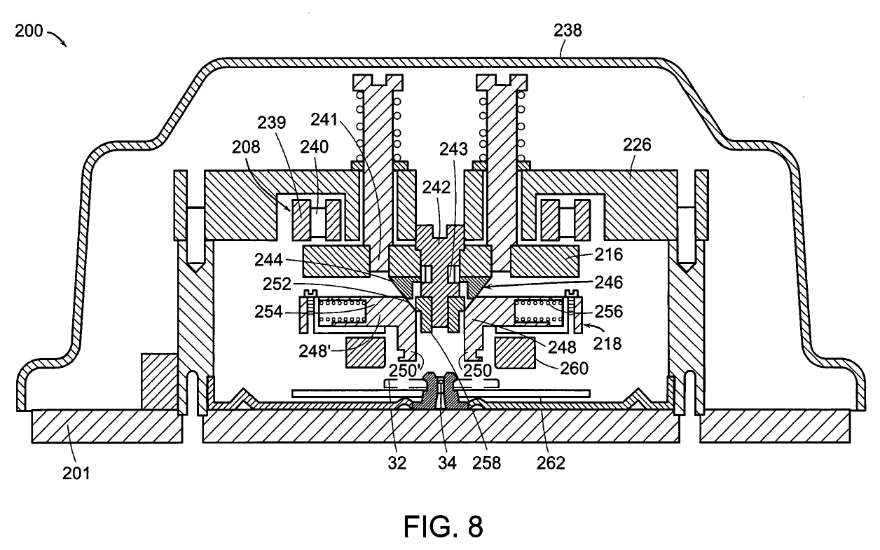

FIGS. 7A and 7B show an embodiment of a release device 200 in a housing 238, and provide reference to the sectional views that are described below. For example, FIG. 8 is the view provided by section B-B of FIG. 7B is shown. In one embodiment, cam 208 has two lobes 239 and a bearing 240 is located between cam lobes 239 of each cam 208. A tip 241 of vertical pin 230 is connected to upper plate 216. A center pin 242 is located within guide hole 236 formed in the central region of crossbar 226. The center pin 242 includes an axial groove 243. A wedge 244 is located below the upper plate 216. Wedge 244 may be included as an integral part of upper plate 216 or attached to upper plate 216 such that the wedge 244 and upper plate 216 move in unison. In one embodiment, wedge 244 has a sloped surface 246 for engagement with arms 248, 248′.

The middle plate 218 comprises arms 248 and 248′ that each comprise a corresponding key 250 and 250′ at its distal end 278, a sloped elbow 252, and a bias spring 256. The middle plate 218 also comprises a middle plate hub 258 to which center pin 242 is connected. Each arm includes a 90° bend. The outer surface of the bend is angled to allow arm 248 to engage wedge 244. Bias spring 256 expansion causes the key 250 to move towards the center of release device 200. In the embodiment of FIG. 8, four identical arms are located substantially every 90 degrees within the middle plate 218. Operating mechanism 214 also comprises lower plate 260 located beneath middle plate 218 and above base 201. After the information storage media 262 is inserted in release device 200, the media is located beneath lower plate 260 and above base 201. A first mechanism spring (not shown) applies a separation force that assists operating mechanism 214 in maintaining separation between upper plate 216 and middle plate 218. A second mechanism spring (not shown) applies a separation force that assists operating mechanism 214 in maintaining separation between middle plate 218 and lower plate 260.

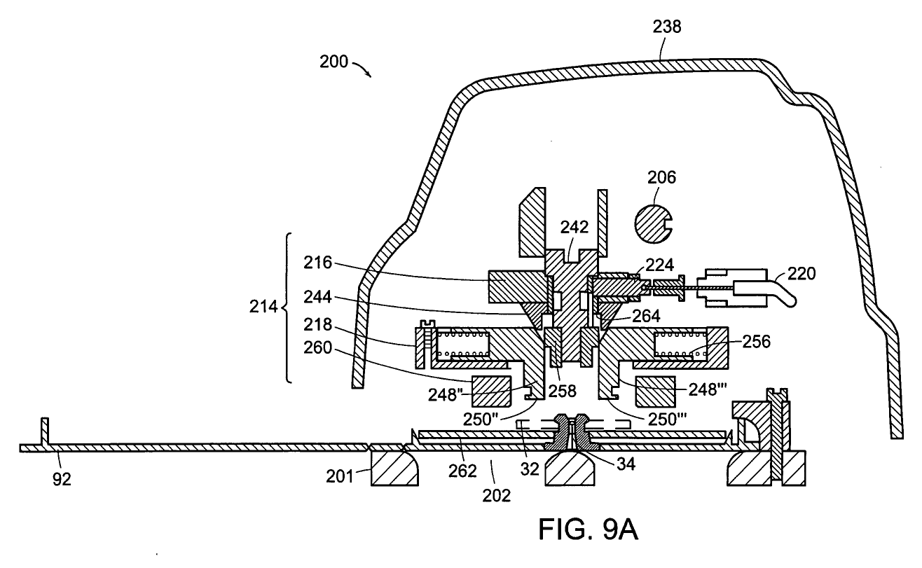

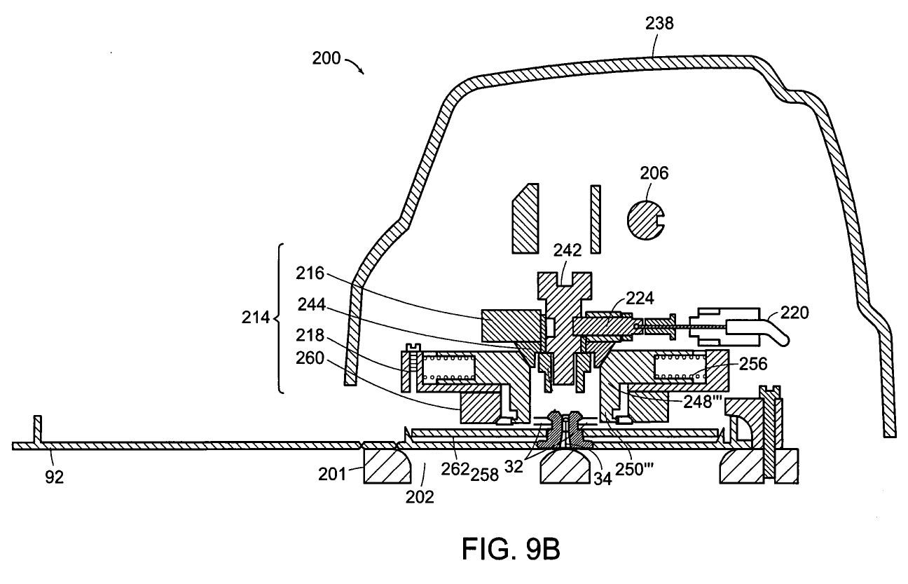

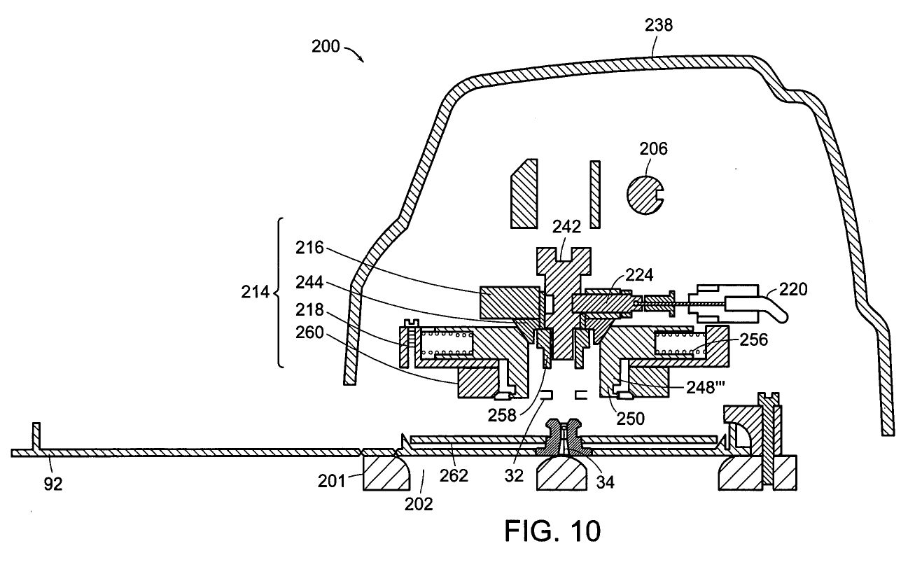

FIGS. 9A, 9B and 10 provide a right side sectional view of operating mechanism 214 of release device 200 employed with a media 262. Each FIGS. 9A, 9B and 10 provides a view of operating mechanism 214 in a different operating state. FIG. 9A is a view of release device 200 with operating arm 203 raised, and media 262 locked by locking device 30 in package 92. FIG. 9B is a view of release device 200 with operating arm 203 lowered and keys 250 inserted in ports 64. FIG. 9C is a view of release device 200 with operating arm 203 raised, locking device 30 unlocked, and post 34 and hub 32 separated. FIG. 9A includes release pin 224, two arms 248″ and 248″′, and corresponding keys 250″ and 250″′ that did not appear in FIG. 8. Front arms 248″ and rear arms 248″′ are located 180 degrees opposite one another and 90 degrees away from the two adjacent arms 248 and 248′ located on the left side and right side of release device 200. Front arm 248″ and rear arm 248″′ are also spring loaded by bias springs 256, and are configured as previously described for the left and right arms 248 and 248′.

FIGS. 7C and 7D show a sectional view along section A-A of FIG. 7A. The release lever 222 is attached to a spring 272 at its proximate end 274 and includes a bumper 276 at its distal end 278. In one embodiment, bumper 276 is a rubber bumper 276 that is secured to the release lever 222 via one or more screws 280. However, bumper 276 can be made of any number of materials including plastic, fabric, metal and the like provided that it will not damage media or media storage cases that are inserted within release device. Release lever 222 pivots around a lever pivot pin 282 and the length of release lever 222 from lever pivot pin 282 to release lever 222 proximate end 274 is shorter than the length of release lever 222 from lever pivot pin 282 to the distal end 278 of release lever 222. One advantage of this configuration is that it provides release lever 222 with sufficient leverage to operate the cable 220 that connects release lever 222 to release pin 224. In FIG. 7D, release lever 222 is shown in a first position that occurs when the media has not yet been inserted within release device 222. In the first position, spring 272 pushes on the proximate end 274 of release lever 222 in a counter clockwise direction when viewed from above. However, when package 92 is inserted in release device 222, bumper 276 engages the media storage case and the release lever 222 is rotated in a clockwise direction to provide slack in cable 220 and allow the release pin 224 to press radically inward.

FIGS. 8-11 each include an information storage media 262, locking device 30, and packaging 92. For example, in the embodiment of FIGS. 8-11, the information storage media 262 is a disk, and the packaging is a disk storage case. However, release device 200 may be employed with a variety of media 262 such as CDs, DVDs, tapes, cassette tapes, micro cassettes, video tapes, floppy disks, miniature floppy disks and the like. In FIGS. 8-11, the locking device 30 comprises a hub 32 and a post 34.

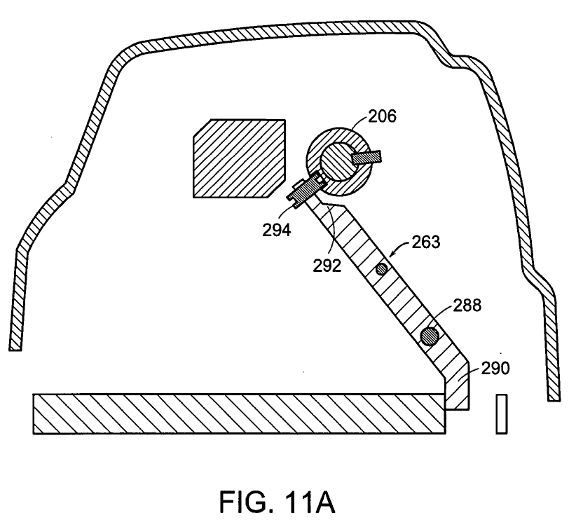

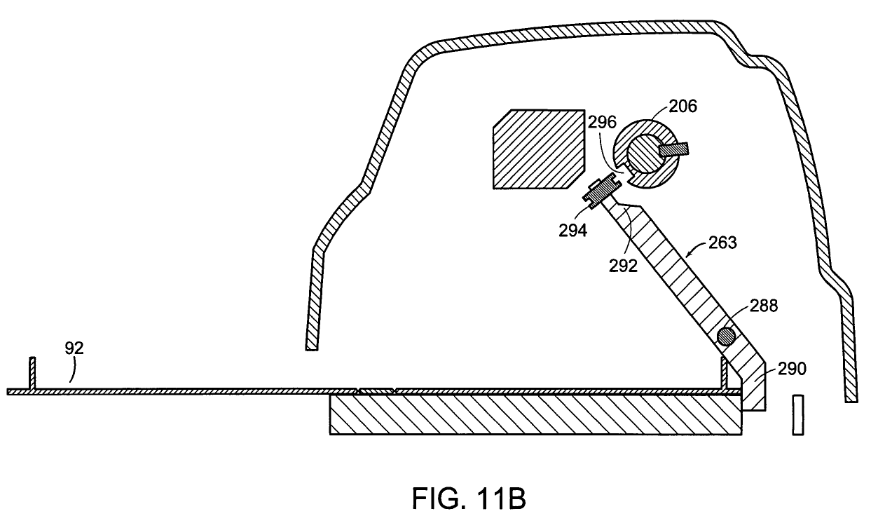

FIGS. 11A and 11B provide a view of an embodiment lockout arm 263 employed with release device 200. FIG. 11A is a view of the lockout arm 263 in a first position that locks release device 200 rendering release device 200 inoperable. FIG. 11B is a view of lockout arm 263 in a second position where release device 200 is operable. Lockout arm 263 rotates about a lockout pivot pin 288. Lockout arm 263 comprises a lower end 290 and an upper end 292. In the embodiment shown in FIGS. 11A and 11B, the distance from lockout pivot pin 288 to upper end 292 is longer than the distance from lockout pivot pin 288 to lower end 290. Upper end 292 also has a locking tab 294 that engages a slot 296 located in shaft 206. FIGS. 11A and 11B show that housing 238 is not flush with the base of release device 200. Instead, housing 238 is raised above base 201 to allow room for media and/or media packaging to be slid beneath the housing 238 and into release device 200.

Referring to FIG. 11B, packaging 92 is opened and inserted in release device 200. Packaging 92 engages lower end 290 of lockout arm 263. Lockout arm 263 rotates counterclockwise as packaging 92 is fully inserted in release device 200. Locking tab 294 rotates out of slot 296 as the lockout arm rotates counterclockwise. In another embodiment, lockout arm 263 movement from the first position to the second position occurs only when a remote sensing interlock receives an authorization signal. The remote sensing interlock may be an electrical device, a mechanical device, an electromechanical device, a hydraulic device, a pneumatic device or the like. Release device 200 may be in electrical communication with a computer system, such as an inventory tracking program, theft detection program, transaction processing program (e.g., point of sale system) and the like. The authorization signal may be provided by the computer system. For example, a point-of-sale system may register a sale or rental of an information storage media and provide an authorization signal to release device 200 as a result.

Release device 200 may also be employed to provide transactional information to a computer system. For example, release device 200 may include a counter that tracks the number of release device 200 operations. Such information allows accurate tracking of the quantity of media that has been unlocked. In another embodiment, release device 200 includes a bar code scanner. This embodiment may be employed with media 262 and media packaging 92 that is bar coded in order to provide even greater detail about each transaction and the nature of the media that is unlocked.

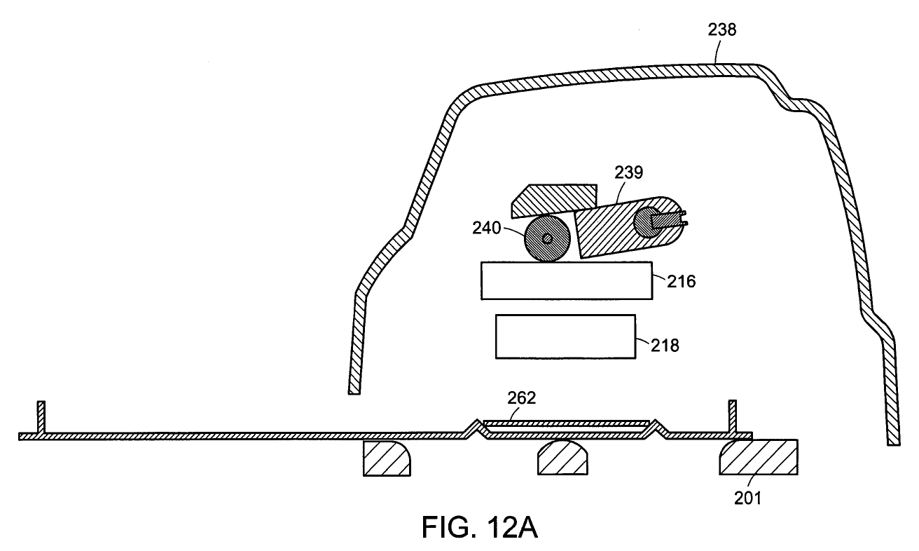

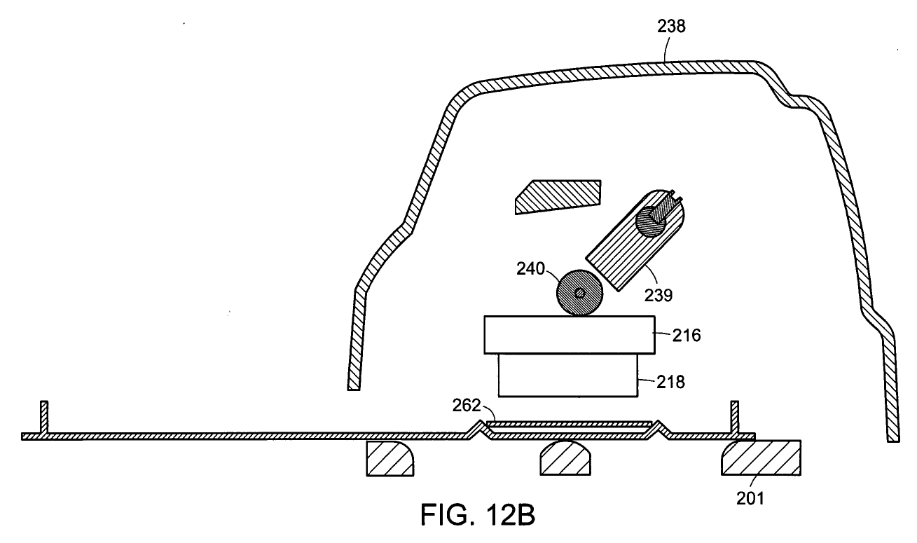

Referring now to FIG. 6, release device 200 is operated by pulling the operating arm 203 downward. The motion of operating arm 203 rotates shaft 206 in a counterclockwise direction when viewed from first end 204 of shaft 206. Referring now to FIG. 9A media 262 has been inserted within release device 200. FIG. 9A shows a right sectional view of the operating mechanism 214 with the operating arm 203 in the raised position. The rotation of shaft 206 causes the cams 208 and associated bearing 240 to rotate with shaft 206 in a counterclockwise direction as the operating arm 203 is pulled downwards. As shown in FIG. 12A bearing 240 contacts upper plate 216. Once contact is made, operating mechanism 214 begins to move downward towards the media 262 secured by locking device 30. First mechanism springs located between the lower plate 260 and the middle plate 218 provide a great enough separation force that the distance between the middle plate 218 and the lower plate 260 does not change at the start of the operating stroke of release device 200. Likewise, a second set of mechanism springs located between middle plate 218 and upper plate 216 provide sufficient separating force that initiation of release device operation does not reduce the gap between the upper plate 216 and the middle plate 218 as shown in FIG. 8.

However, as the operating handle 203 is moved downward, the lower plate 260 begins to move downward until it comes in contact with the outside edges of a hub 32. In one embodiment, the surface of the lower plate 260 that engages a hub 32 is angled to provide more consistent engagement and optimum alignment of a hub 32 beneath the operating mechanism 214 of release device 200. Lower plate 260 stops travelling downward when it reaches the bottom of its operating stroke (i.e., it is in full contact with hub 32). However, the middle plate 218 now overcomes the separating force of mechanism springs located between it and lower plate 260. Middle plate 218 continues to travel downward until the lower surface of middle plate 218 strikes the upper surface of lower plate 260. At that time, the middle plate 218 also stops travelling downward and the keys 250, 250′ are inserted in the ports 64 located in top plate 42 of hub 32. Up until this point in the operating stroke of release device 200 a release force has not been applied to hub 32. However, as operating handle 203 continues to travel downward (i.e., counterclockwise rotation of shaft 206), upper plate 216 and the attached wedge 244 continue to travel downward. Downward travel of wedge 244 allows sloped surface 246 to more fully engage sloped elbows 252. Continued downward travel of wedge 244 results in application of a radially directed force on each of arms 248. The force is radially outward from the center of hub 32. The greater the engagement between wedge 244 and arms 248 the greater distance that arms 248 are moved radially outward. In the embodiment of FIGS. 9A-9C, keys 250 engage lock mechanism 65 and force locking members 68 in a radially outward direction away from post 34. This release force releases hub 32 from locking engagement with post 34.

Additionally, as wedge 244 moves downward, the gap that existed between central region 264 of wedge 244 and the upper side of middle plate hub 258 is closed until central region 264 and middle plate hub 258 come in contact with one another. Because center pin 242 is stationary during the final portion of the downward operating stroke of operating mechanism 214, release pin 224 moves downward with upper plate 216 relative to center pin 242. As a result, release pin 224 aligns with axial groove 243 in center pin 242. Release pin 224 slides into axial groove 243 when they align.

As a result, upper plate 216, middle plate 218, and lower plate 260 are in a fixed spatial relationship with one another. This occurs with operating mechanism 214 in a compressed state whereby the distance between upper plate 216 and lower plate 260 is at a minimum. Further, as mentioned above, hub 32 is unlocked. As shown in FIG. 9C, the sequence of operations continues with the operating arm 203 being raised (i.e., clockwise rotation of shaft 206 when viewed from first end 204). This operation removes hub 32 from the post 34. Further, so long as the operating mechanism 214 remains in a compressed state hub 32 is secured within the release device.

This compression will not be released until the storage case and media are removed from the release device. In the embodiment shown in FIGS. 7C and 7D, the package 92 must be withdrawn from release device 200 before release lever 222 rotates back to the release position shown in FIG. 7C. The release lever spring 272 applies a force that pushes the proximate end 274 of release lever 222 to the right side of release device 200. As a result, tension on cable 220 is increased and release pin 224 is withdrawn from axial groove 243. When this occurs, the middle plate 218 and the upper plate 216 move downward along with the center pin 242 and lower plate 260. Wedge 244 and middle plate 218 separate and, as a result, the radially applied release force is eliminated. Consequently, each of the arms 248 is pushed radially inward by bias springs 256, and keys 250 align with corresponding ports 64. When keys 250 are aligned with ports 64, hub 32 will be released by the release device and drop through opening 202 in base 201 of release device 200. Hub 32 drops into an adjacent hub storage area. The packaging 92 and media 262 are available for use. As previously described, both packaging 92 and hub 32 can be reused for multiple operations.

In another embodiment, the release device is electrically operated. In a version of this embodiment, the electrical operator includes a solenoid or coil that receives an authorization signal. Operation of release device 200 may be initiated by a lockout limit switch that senses when the media or media storage case are fully inserted within release device 200. In this embodiment, release device 200 operates when full insertion is sensed. In another version, operation is initiated when a store clerk depresses a foot pedal.

In one embodiment, the release device may be mounted adjacent a sale or rental counter. The locking device 30 is removed following the rental or sales transaction. Using the counter-mounted release device, hub 32 is engaged with keys 250 and then the packaging is rotated in order to release hub 32. This provides a quick and easy means of releasing the secured media for sale or rental.

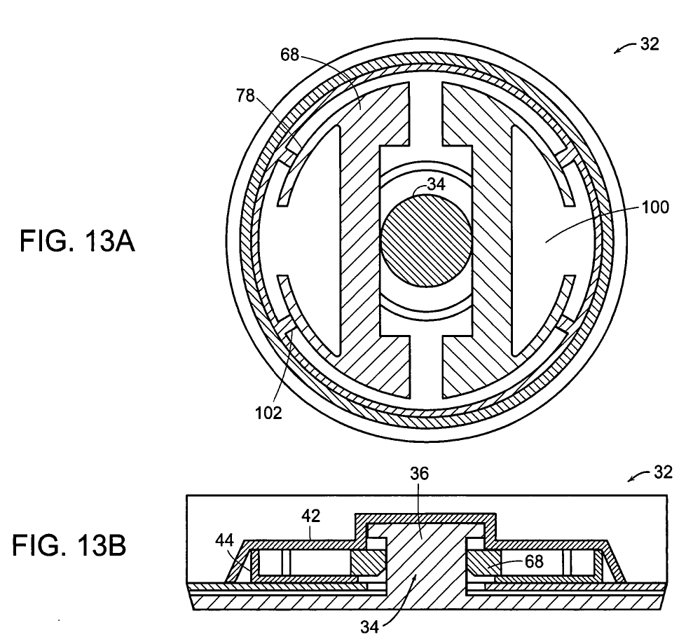

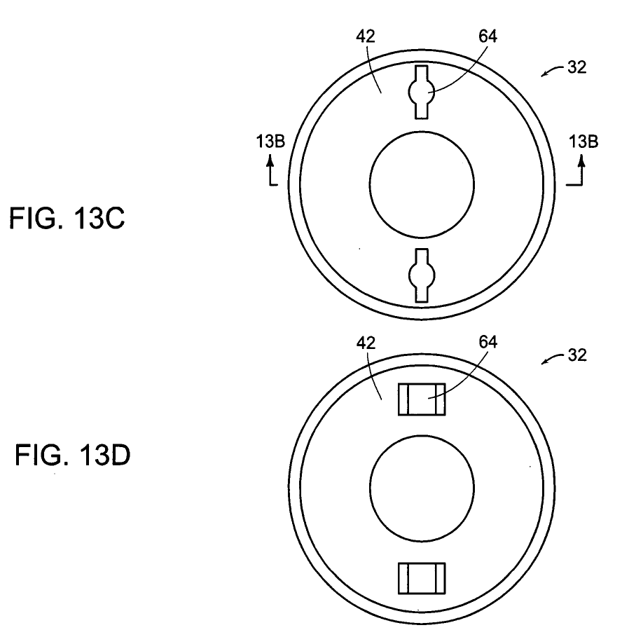

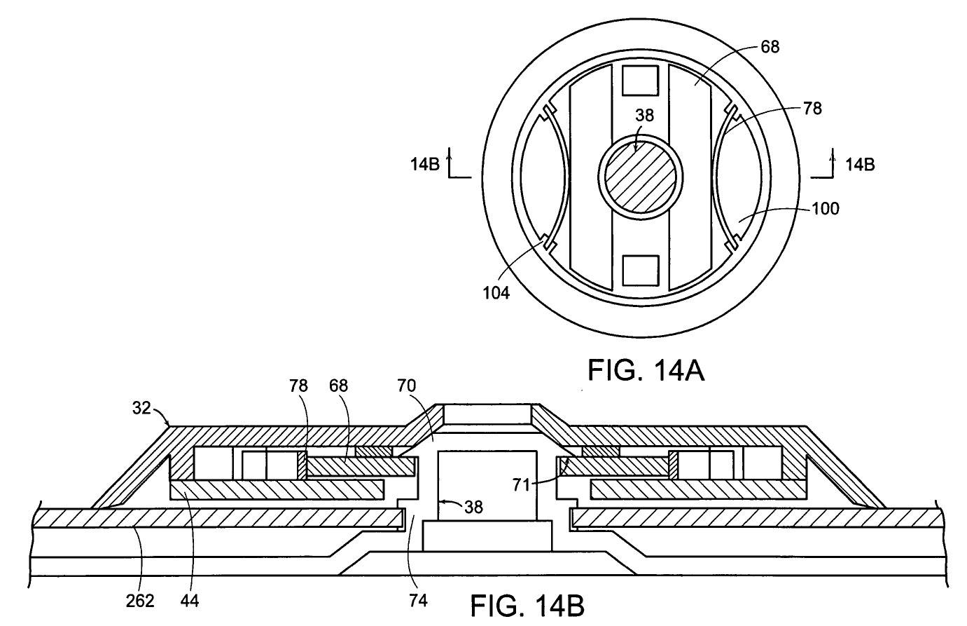

Another embodiment of the locking device 30 depicted in FIGS. 13A-13D, includes a hub 32 and a post 34. The lock mechanism 65 is retained inside a cavity 100 within hub 32 and includes two locking members 68. Each locking member 68 substantially spans the diameter of the cavity in which the lock mechanism 65 is enclosed. Lock spring 78 comprises tongues extending from each end of locking member 68. The lock springs 78 each engage an abutment 102 extending from the housing 238 into the cavity. The lock springs 78 bias each of the locking members 68 radially inward toward the center of hub 32 so that locking members 68 will engage post 34 when in use. The top plate 42 of the embodiment shown in FIG. 13 includes two ports 64. The ports 64 are located so that they align with a space in the lock mechanism 65 between the two locking members 68. The embodiment shown in FIG. 14 does not include a top plate 42 opening. However, as described previously, central opening 66 is included to receive the post 34. In use, central opening 66 is aligned with post 34. The hub 32 is then set on the post 34. When hub 32 is first pressed onto the post 34 an inner face 83 of the lower surface of each of the locking members 68 engages the head of post 34. The spring bias provided by the first lock spring 78 and the second lock spring 78 of each of the two locking members 68 is overcome and the locking members 68 move away from the hub 32 center. This motion provides enough clearance for head 36 to slip between the two locking members 68. Once head 36 clears the two locking members 68, the spring bias forces the two locking members 68 back into engagement with the stem 40 as shown in FIG. 13B. Information storage media will remain locked about the stem 40, sandwiched between hub 32 and base 38 of post 34, until locking members 68 are separated using a release device and the hub 32 is removed. As shown in FIGS. 13C and 13D, the top plate 42 has two ports 64. When hub 32 is assembled, the ports 64 align with a space between the first locking member 68 and the second locking member 68.

FIGS. 14A and 14B show a further embodiment of a locking device 30 according to the invention. In FIG. 14, hub 32 is shown with an top plate 42 and bottom plate 44 that form cavity 100 when hub 32 is assembled. The lock mechanism 65 is located in the cavity 100 formed by hub 32, and comprises two leaf lock springs 78 and two locking members 68. The lock springs 78, located on opposite sides of cavity 100, are secured in place by spring retainers 104. In use, locking members 68 are located on either side of the post 34. The locking members 68 include a first edge and a second edge. The first edge of each locking member 68 is engaged by one of the lock springs 78, and the second edge of each locking member 68 engages post 34 at engagement surface 71 when the locking device 30 is in use.

FIG. 15 shows yet another embodiment of a locking device 30 in accordance with the invention. In this embodiment each of the first and second locking members 68 include a spring tab 106 and a helical lock spring 78. Tab 106 is located on the first edge of each locking member 68. The helical lock spring 78 is centered over tab 106 and compressed between an edge of locking member 68 and the walls formed by the cavity 100 within hub 32. A spring bias on the locking members 68 is provided by the lock spring 78 in a radially inward direction towards the hub 32 center.

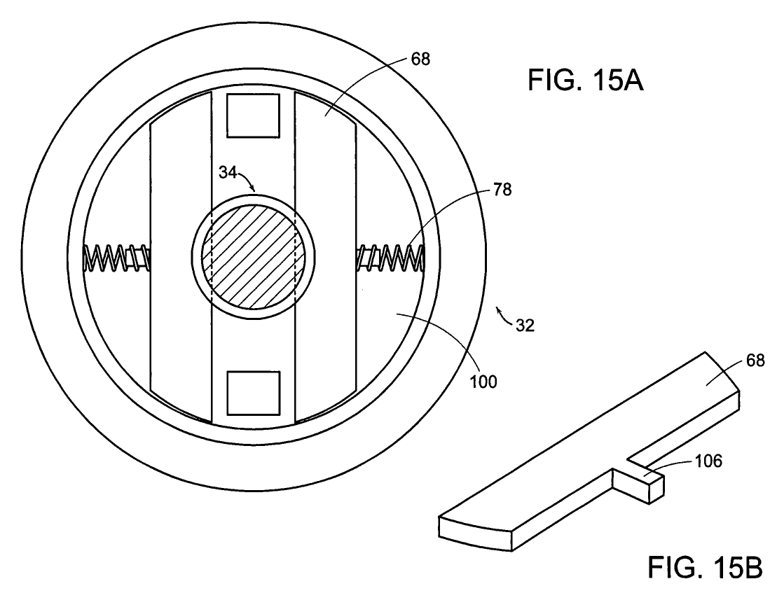

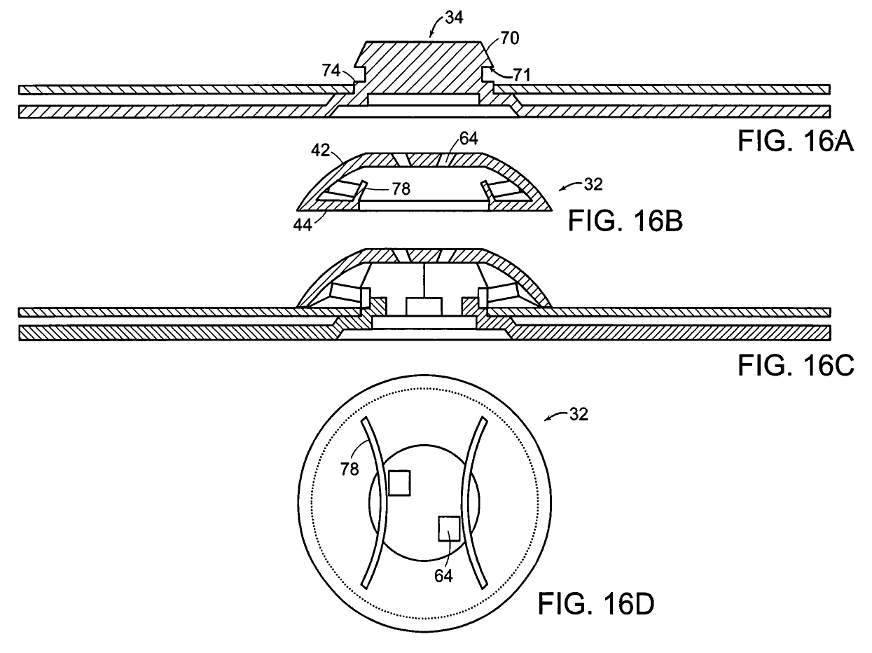

Referring now to FIG. 16, a further embodiment of a locking device 30 is shown. The post 34 includes an engagement surface 71. Hub 32 comprises an top plate 42, a bottom plate 44, and two leaf-style lock springs 78. Additionally, the top plate 42 includes two ports 64. In operation central opening 66 in a bottom plate 44 is aligned with the post 34. When hub 32 engages the post 34 leaf and the lock springs 78 are pushed radially outward along the ledge 70 until hub 32 is pressed far enough on the post 34 that the lock springs 78 move radially inward beneath the engagement surface 71 of post 34. This embodiment may be unlocked with a release device 200 that comprises two arms that are flexible and extend through the ports 64 and corresponding openings in post 34 in order to drive the lock springs 78 radially outward. Hub 32 can be removed from the post 34 and the media may be removed from the locking device 30.

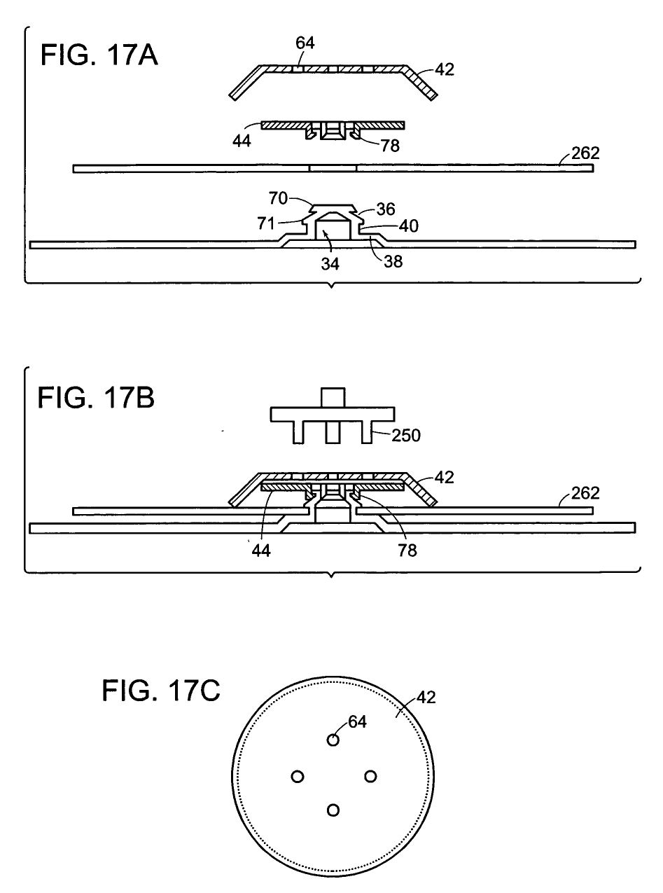

Referring now to FIGS. 17A-17C yet another embodiment is shown. Hub 32 of this embodiment includes a top plate 42 and a bottom plate 44 that are attached to one another. They may be attached by any number of means such as welding or gluing. The top plate 42 has four ports 64 that are spaced 90° apart. The lock springs 78 extend perpendicularly beneath the bottom plate 44. A latch is located at a distal end of each lockspring 78. In use, hub 32 is aligned with post 34 and then pressed onto the post 34. When this occurs the latches engage the ledge 70 on post 34 and are forced radially outward until the hub and post 34 are fully engaged when the lock springs 78 force the latches radially inward where they are secured beneath the engagement surface 71. The release device for this embodiment includes a pronged key 250 wherein, in use, the keys 250 are inserted through the top plate 42 and pressed down on each latch. The keys 250 spread the latches radially outward away from post 34 thereby releasing hub 32 form post 34.

The locking device 30 can be accomplished with a number of post/hub configurations. For example, a post 34 could include a stem 40 without a head 36, wherein locking members 68 extending from hub 32 engage recesses within the post 34. In this embodiment, the lock will remain locked until all locking members 68 are retracted and the hub 32 is removed from the post 34.

Additionally, in still a further embodiment, the lock mechanism can be located within the base. In such an embodiment, the post is not equipped with head. The media is locked between hub and the base after the media is slid over the post and hub is pressed on the post. The post is hollow and the hub includes a rod that is inserted within the post when hub is pressed on the post. The bottom of the rod includes an engagement surface that is captured by the lock mechanism when the lock is in use. Hub includes a keyway that allows a release device to be inserted within the locking device to unlock locking device.

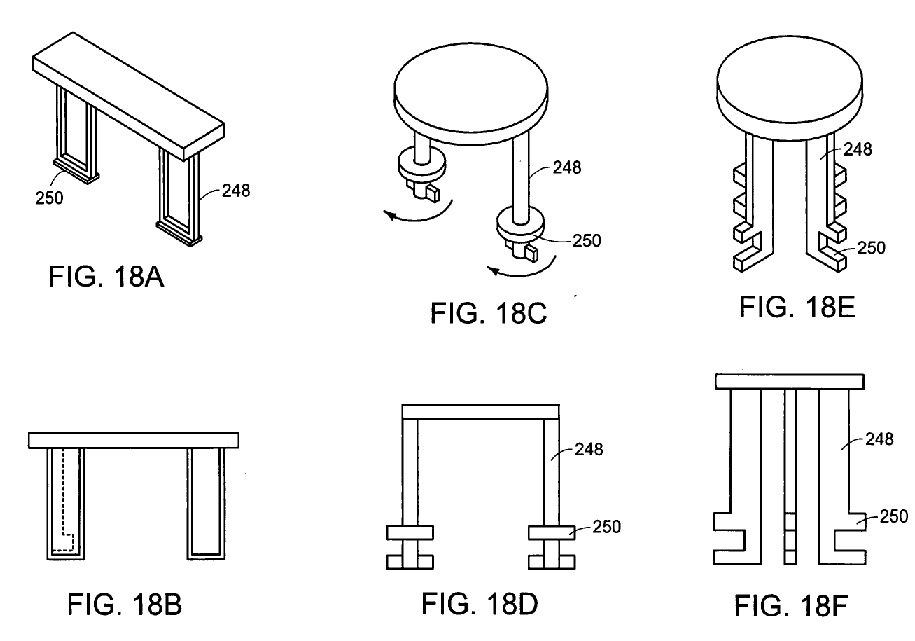

Referring to FIGS. 18A-18F, a variety of key 250 embodiments are shown for use with one embodiment of release device 200. Generally, release device 200 operates by engaging the lock mechanism 65, overcoming the spring bias, and forcing the locking members 68 away from the center of hub 32 to provide clearance between locking members 68 and engagement surface 71. The embodiments of FIGS. 18A-18F may, for example, be employed with hubs 32 depicted in FIGS. 13-15. Keys 250 are inserted through ports 64. Once inserted, either key 250, hub 42 or both are rotated in order to engage locking mechanism 65 and separate locking members 68. For example, the embodiment shown in FIG. 18C, may be employed with hub 32 of FIGS. 13A-D, and the separate versions of top plate 42 shown in FIGS. 13C and 13D. The combination of this hub 32 and key 250 results in a device where each key 250 engages each locking member 68 of hub 32 when locking device 30 is unlocked. Further, the engagement opening 82 of hub 32 is located between the inner face 83 of locking members 68. In the embodiment of FIGS. 13A-D, the engagement opening 82 is not located within locking members 68.

One advantage that may be realized by the invention is benefit denial. For example, unauthorized or illegal access to a functional disk is denied because attempts to remove the locking device 30, without the appropriate release device, will likely damage the disk and deny the thieves the benefit of their theft. This result can be achieved when the locking device 30 is employed with the media 262 alone, or with the media 262 and various forms of packaging 92. Benefit denial results from one or a combination of the following features of locking device 30: use of materials that substantially resist cutting; hub 32 and base 38 diameters greater than the diameter of the opening in the media with which the locking device 30 is employed; multi-point locking whereby a plurality of locking members 68 must moved to unlock locking device 30; and multi-directional locking forces that require locking members be moved in different directions from one another to unlock locking device 30.

Knives and hand tools are ineffective in locking device 30 removal when the locking device 30 is manufactured from materials that substantially resist cutting. A locking device where all the exposed surfaces are made from material that substantially resists cutting will likely also prevent removal of the locking device from the media. Further, other commonly available tools are ineffective in unlocking the locking device 30 both because the locking device 30 only allows limited access, via ports 64, to the lock mechanism 65, and because a multi-directional locking force is employed by the locking device 30. Additionally, in one embodiment, the multiple release points must all be retracted making it nearly impossible for the hub 32 to be removed with the use of commonly available tools such as screwdrivers, pliers, and the like. Thus, even for thieves with great dexterity, it is nearly impossible to insert one or more tools into ports 64 in manner that would allow each of the locking members 68 to be forced to an unlocked position.

The locking device 30 can be incorporated in media packaging 92 at any point in the distribution chain. For example, locking device 30 lends itself to deployment at the time of manufacture. In one embodiment, an automated method of manufacturing locked media includes locking device 30. As a result, newly manufactured media, newly packaged media, or newly manufactured and packaged media may be securely shipped to a point of sale or rental. A locking device system can comprise one or more of the locking device 30 and release device 200 in various applications. Further, the locking device system can be used with existing Electronic Article Surveillance systems that incorporate magnetic tags, radio frequency tags or other technologies.

While the invention has been shown and described with reference to specific embodiments, it should be understood by those skilled in the art that various changes in form and detail may be made therein without departing from the spirit and scope of the invention.

What is claimed is:

1. A locking device for use with an information storage media, the locking device comprising:
a post having a head on a first end, a base on a second end, and a stem therebetween; and
a hub that secures to the head wherein at least one of the hub and the head comprises a locking member that operates in a radial direction to allow a removable engagement of the hub and the head,
wherein, in use, the device is secured to the information storage media such that the stem passes through an opening located within the media and the base and head are located on opposite sides of the media.

2. The locking device as claimed in claim 1 wherein said locking member operates in a radially inward direction.

3. An anti-theft system comprising:
the locking device of claim 1; and
a release device comprising a first key for applying a first release force in a first direction and a second key for applying a second release force in a second direction,
wherein the first direction and the second direction are different, and
wherein the locking device is unlocked when both the first release force and second release force are applied to the locking device.

4. The locking device as claimed in claim 1 wherein the hub comprises the locking member and a spring.

5. The locking device as claimed in claim 4 wherein the hub comprises a plurality of locking members.

6. The locking device as claimed in claim 5 wherein at least one locking member comprises a slide.

7. The locking device as claimed in claim 1 wherein the head has a top surface comprising a shape that is selected from the group consisting of circular, triangular, parallelogrammatic, polygonal, and cross-shaped.

8. The locking device of claim 1 wherein the base has a first diameter,
wherein the opening within the information storage media has a second diameter, and
wherein the first diameter is greater than the second diameter.

9. The locking device of in claim 1 wherein the head includes an engagement surface, and wherein, when in use, the locking member contacts the engagement surface when the hub is engaged with the head.

10. The locking device as claimed in claim 3 wherein the hub comprises at least one port, and wherein, when the release device is in use, at least one of the first key and the second key is inserted in the at least one port to operate the locking member.

11. The locking device as claimed in claim 1 further comprising packaging, the packaging comprising a media storage cavity wherein, when the device is in use, the head is located within the media storage cavity, and wherein, when in use, the base remains external to the media storage cavity.

12. A method of controlling use of an information storage media, the method comprising securing the locking device of claim 1 to the media to thereby render the information storage media inoperable.

13. The method of claim 12 wherein external surfaces of the locking device are manufactured from material that substantially resists cutting.

14. The method of claim 12, further comprising the step of unlocking the locking device, for an authorized use, by applying a multi-directional release force to the device.

15. The method of claim 12, further comprising the step of unlocking the locking device upon an occurrence of at least one of a media sale and a media rental.

16. The method of claim 12, further comprising the step of unlocking the locking device by applying the release force in a direction substantially parallel to a planar surface of the media, wherein the media is a disk.

17. The method of claim 12 wherein the media is locked within packaging.

18. A release device for removing a locking device from an information storage media, the release device comprising:
an operating mechanism comprising at least two keys wherein the keys engage the locking device, and
wherein at least two of the at least two keys move in different directions when the release device is operated to unlock the locking device and allow the locking device to be removed from the media.

19. The release device as claimed in claim 18 comprising a lockout device wherein the lockout device disables the release device until an authorization signal is received by the release device.

20. The release device as claimed in claim 19 wherein the authorization signal is produced by a computer system when at least one of a media sale and a media rental occur.

21. An anti-theft system comprising:
the locking device of claim 1; and
a release device to release the hub from the post for an authorized use wherein the release device provides a multi-directional release force, and wherein the release force comprises at least one radially directed force.

22. The system as claimed in claim 21 wherein the release device is in electrical communication with a computer system.

23. The system as claimed in claim 22 wherein the computer system comprises an inventory tracking program.

24. The system as claimed in claim 22 wherein the computer system comprises a theft detection program.
